(19) United States
(12) Patent Application Publication
(10) Pub. No.: US 2005/0289192 A1
(43) Pub. Date: Dec. 29, 2005

(54) Dynamic navigation systems and methods

(75) Inventors: Edward J. Tromczynski, Hudson, OH (US); John R. Vojtush, Aurora, OH (US); John D. Hewitt, Cleveland Heights, OH (US); Marque N. Staneluis, Brooklyn, NY (US)

Correspondence Address: HAHN LOESER & PARKS, LLP, One GOJO Plaza, Suite 300, AKRON, OH, 44311-1076, US

(73) Assignee: Onvantage

(21) Appl. No.: 11/041,901

(22) Filed: Jan. 24, 2005

Related U.S. Application Data
(60) Provisional application No. 60/538,680, filed on Jan. 23, 2004.

(51) Int. Cl. G06F 12/00

(52) U.S. Cl. 707/200

(57) ABSTRACT

The invention is directed towards methods and systems for centrally administering navigational portions or mastheads of multiple web pages. In an embodiment, a computing device has a web page displayed on the computing device. A conversion utility is accessible via the Internet, and a file having navigation source code is provided. As the web page is loaded, the computing device sends a request for resultant code to the conversion utility. The conversion utility upon receiving the request retrieves the file having navigation source code and converts the navigation source code into resultant code. That resultant code is then transmitted back to the computing device and is loaded by the web page. Because the resultant code is generated when requested, the web page always receives the most recent version of the resultant code. In this sense, dynamic navigation is provided.

This application claims the benefit of U.S. Provisional Application No. 60/538,680 filed Jan. 23, 2004.

### TECHNICAL FIELD

The present invention relates to methods and systems for centrally administering navigational portions of multiple websites and more particularly to administering navigational code at a central location and dynamically transmitting that code to multiple websites through the use of resultant scripts.

### COPYRIGHT RESERVATION NOTICE

Portions of this patent, including without limitation this particular document and its corresponding patent office records, disclose material subject to copyright protection. This material includes without limitation the source code and screen shots of the disclosed embodiments. The copyright owner has no objection to the paper reproduction of these patent documents as they appear in the Patent and Trademark Office records; however, the copyright owner expressly reserves all other rights whatsoever. The following notice applies to all material subject to copyright protection: “Copyright 2003 PlanSoft Corporation. All Rights Reserved.”

### BACKGROUND OF THE INVENTION

Use of the Internet in recent years has steadily increased at a significant rate. Many users now regularly shop, work, research, socialize, and even attend school via the Internet. This, in turn has led to an astonishing number of websites accessible via the World Wide Web. At least one of today's search engines presently indexes well over three billion web pages.

Each one of these websites may be as unique as its author. There is no set format for content or arrangement. That being said, similarities do exist. Once such similarity is that websites usually include hyperlinks for site navigation. These hyperlinks are often grouped together so as to form a navigation section or masthead. Mastheads may be incorporated into websites in a variety of ways. A website may, for example, use frames. One popular method of framing is to include a top frame and a bottom frame. The top frame makes up the masthead while the substance of the website is displayed within the bottom frame. In another popular embodiment, the same effect is accomplished without using frames. The masthead is simply included on the same portion of every web page within a website.

Webmasters face enormous challenges in maintaining these mastheads. Webmasters often are responsible for expansive sites that include hundreds, if not thousands, of individual web pages. If each of these pages contains a masthead (and corresponding html code), then that section of each page must be modified every time navigational link information (the link name or its URL address) changes. Further complicating maintenance is the fact that many websites interact with other websites. For example, a hotel chain may offer meeting planning services on its website. A separate meeting planning company actually develops, administers and provides the meeting planning services. Such an arrangement necessitates links from the hotel masthead to portions of the meeting planning company's website and visa versa. If one of the companies changes the structure of its website, then the other must update its navigational links that link to the first company's web pages. As a result of these challenges, website administration has become increasingly time-consuming and costly.

### SUMMARY OF THE INVENTION

Methods and systems for centrally administering navigational portions or mastheads of multiple web pages are presented herein. The invention in one aspect comprises a computing device, a web page displayed on the computing device, a conversion utility accessible via the Internet, and a file having navigation source code. As the web page is loaded, the computing device sends a request for resultant code to the conversion utility. The conversion utility upon receiving the request retrieves the file having navigation source code and converts the navigation source code into resultant code. That resultant code is then transmitted back to the computing device and is loaded by the web page. Because the resultant code is generated when requested, the web page always receives the most recent version of the resultant code. In this sense, dynamic navigation is provided.

### BRIEF DESCRIPTION OF THE DRAWINGS

FIG. 1 is a graphical representation of a dynamic navigation system according to the present invention.

FIG. 2 is a graphical representation of the process of dynamically updating a navigational masthead according to the present invention.

FIG. 3 is a graphical representation of the process of dynamically updating a navigational masthead according to the present invention.

FIG. 4 is a graphical representation of a dynamic navigation system according to the present invention.

FIG. 5 is a graphical representation of a web page.

FIG. 6 is a graphical representation of a web page according to the present invention.

FIG. 7 is a graphical representation of a portion of html source code according to the present invention.

### DETAILED DESCRIPTION

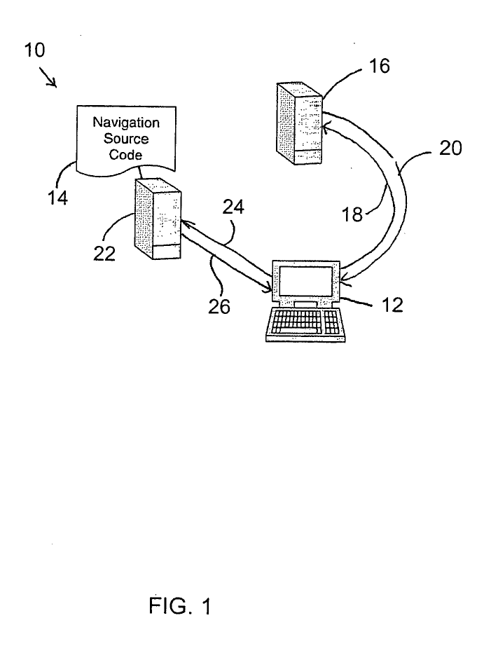

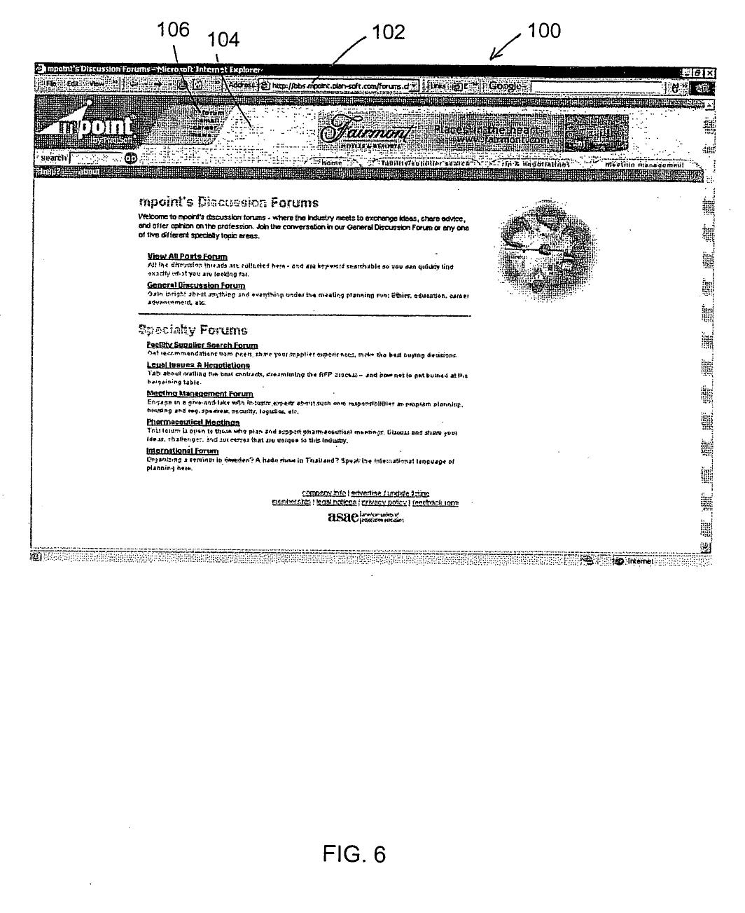

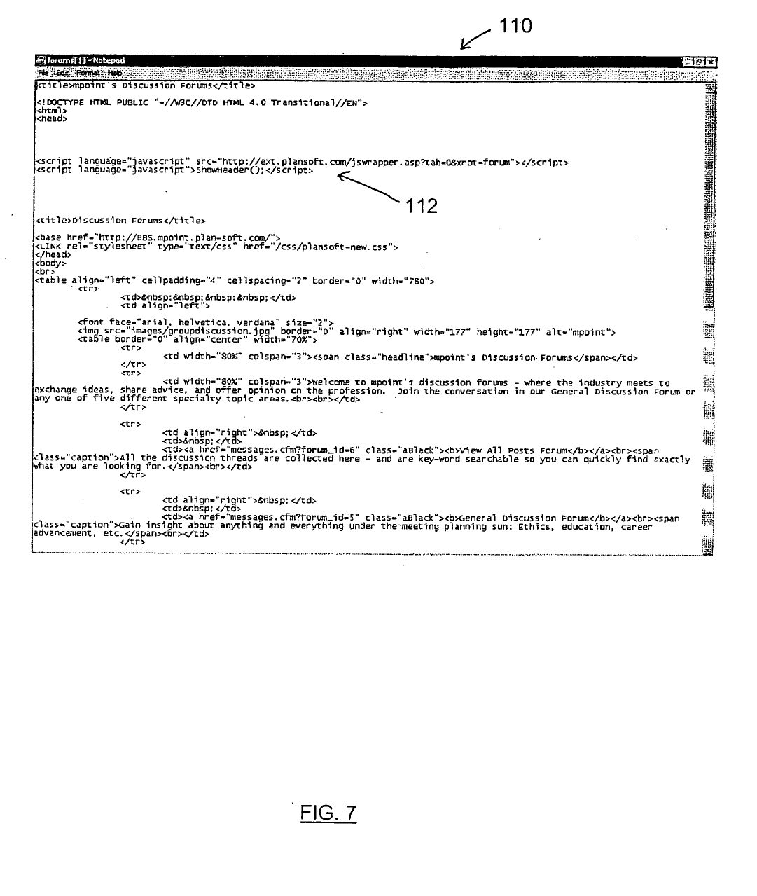

FIG. 1 is a graphical representation of an embodiment of a dynamic navigation system according to the present invention. This embodiment comprises a computing device 12, a web page 100 (FIG. 6) displayed on the computing device 12, a conversion utility accessible via the Internet, and a file having navigation source code 14. The web page 100 is obtained by the computing device 12 from a remote web server 16. This process is characterized in that the computing device 12 sends a request 18 to the remote web server 16 for source code 110 (FIG. 7) for the web page 100. The remote web server 16 then transmits 20 the source code 110 to the computing device 12. The same process is used for retrieving other objects such as images that make up the web page 100.

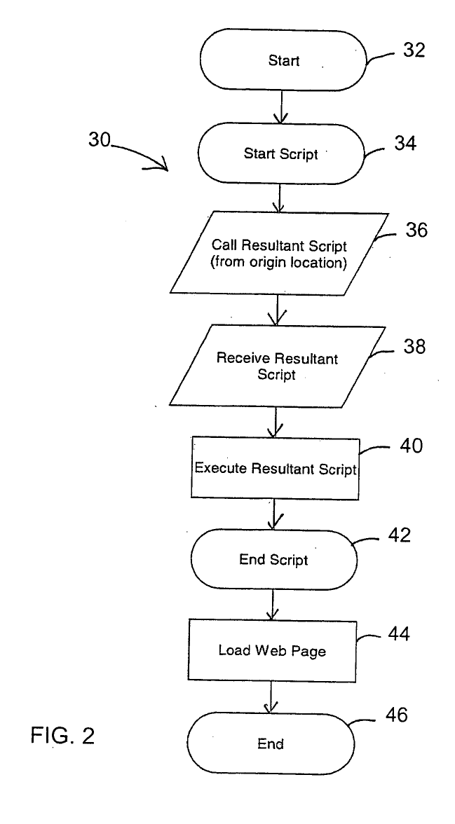

The computing device 12, upon receiving the source code 110, starts 32 (FIG. 2) executing it (e.g. loads the page). One of the commands in the source code initiates 34 a subroutine. In an embodiment, the subroutine may be a JavaScript and the command that initiates that script reads ‘<script language=“javascript” . . . ’. Use of alternative scripting languages such as Microsoft® Visual Basic® or Microsoft® C# or the like, are contemplated. The functions of the subroutine are not embedded in the source code 110. Rather, the subroutine contains a command that directs the computing device 12 to a file location for the subroutines. In an embodiment, this command may read ‘ . . . src=“http://ext.plansoft.com/j swrapper.asp?tab=0&xrot=forum”>’. The computing device 12 then sends 36 a request 24 for the functions of the subroutine to the file location 22 for the subroutines. The file location 22 for the subroutines may be local to the remote web server 16, or may be remote from it. The terms local and remote may be interpreted without limitation to distinguish between within the same domain and differing domains or within the same file and differing files.

The functions of the subroutine are formatted into resultant code. The resultant code is generated by the conversion utility and is then sent to the computing device 12. Upon receipt 38, the commands of the subroutine are executed 40. After execution, the subroutine terminates 42, any remaining source code for the web page executes 44, and the page-load process terminates 46.

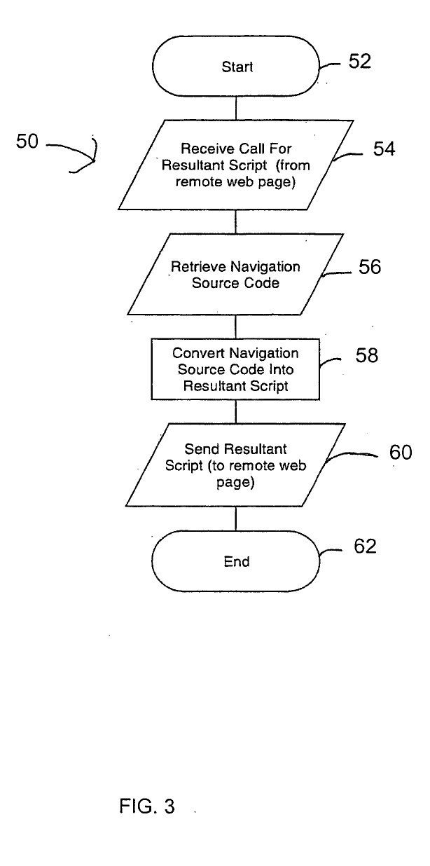

FIG. 3 is a graphical representation of the process 50 used to generate resultant code. The conversion utility upon receiving 54 a request for resultant code 24 retrieves 56 the navigation source code 14. The navigation source code 14 may be generated using any language resulting in a markup language file, including not by way of limitation ASP, PHP, Python, and CGI. Currently popular markup language formats include not by way of limitation HTML, XML, SGML, and XHTML. Once retrieved, the various commands of the navigation source code 14 are converted 58 from markup language format into resultant code. In an embodiment, the resultant code is comprised of JavaScript commands. That resultant code is then transmitted 60 back to the computing device 12 for execution. Because the resultant code is generated when requested, the web page 100 always loads with the most recent changes to the navigation source code 14 incorporated therein. In this sense, dynamic navigation is provided.

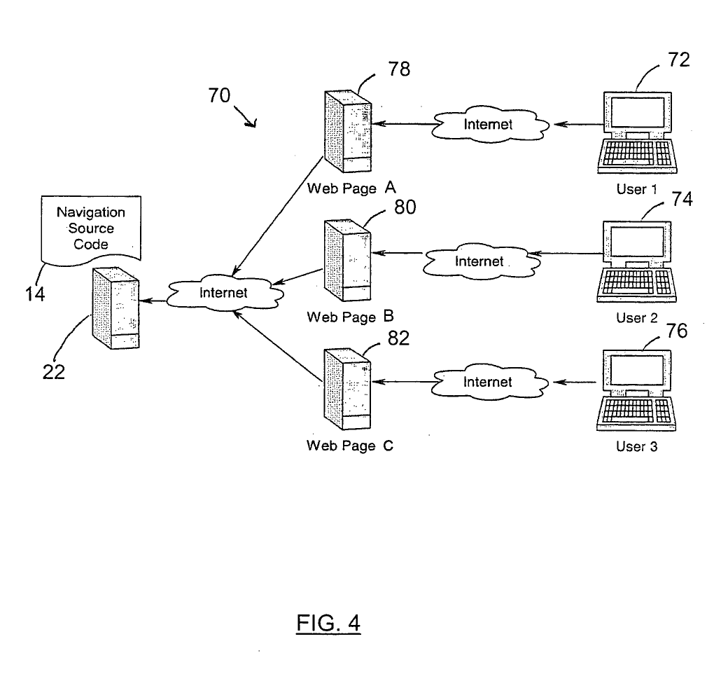

FIG. 4 is a graphical representation of a dynamic navigation system according to an embodiment of the present invention. Multiple users 72, 74 & 76 accessing different websites 78, 80 & 82 are provided navigational mastheads that originate from the same navigation source code 14. When user one 72 visits web page A 78, source code is downloaded. One of the commands within the source code initiates 34 a subroutine. User one's 72 computing device then sends a request to the file location 22 for the functions of the subroutine. A conversion utility stored at the file location 22 for the functions of the subroutine retrieves navigational source code 14 and converts that code into resultant script functions that are transmitted back to user ones 72 machine. The script functions are executed and the remainder of the web page loads.

Users two 74 and three 76, while visiting sites B 80 and C 82 respectively, similarly are provided with source code that contains the same subroutine initiation command. That command results in a call by the computing devices of users two and three to the same file location 22 for the functions of the subroutines. Similarly, resultant code is generated and returned to users two 74 and three 76. All three users 72, 74 & 76 are provided with the same basic navigational masthead, but on different websites 78, 80, and 82. Whenever a change is made to the navigational source code 14, the mastheads of the various websites are automatically “updated” by virtue of the fact that each masthead is generated whenever users visit the various websites 78, 80, and 82.

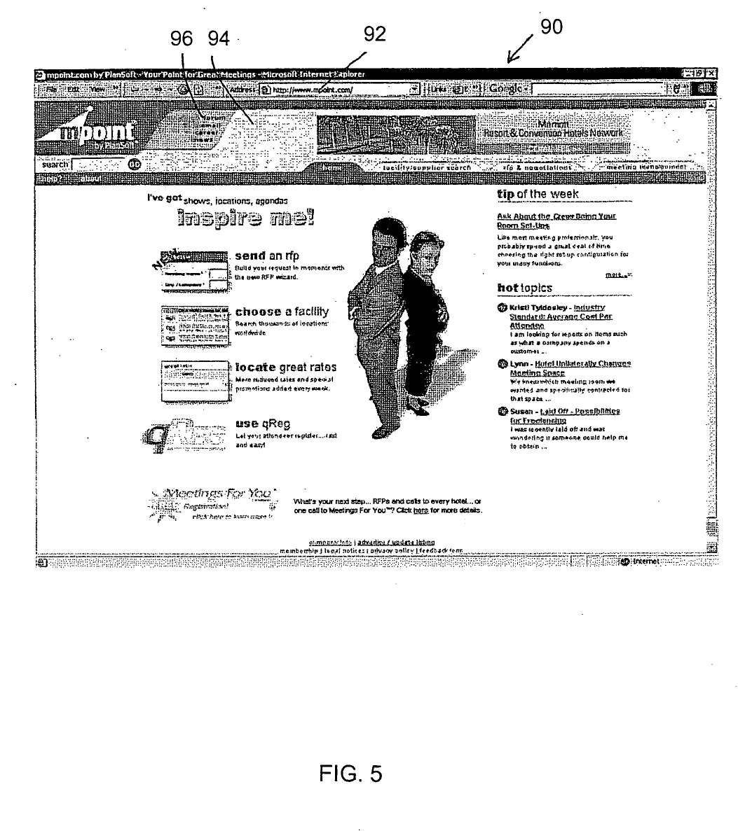

FIGS. 5 & 6 are graphical representations of two different web pages 90 & 100. FIG. 7 is a graphical representation of a portion of the html source code of the second web page 100. Both web pages 90 & 100 contain similar mastheads 94 & 104. When a site visitor clicks the “forum” hyperlink 96 on the first web page 90, the second web page 100 loads. It is readily apparent from the address bars 92 & 102 of FIGS. 5 & 6 that the two web pages 90 & 100 are hosted at different domains or locations.

The masthead 104 of the second web page 100 is generated according to the present invention. As this web page 100 loads, a source code command 112 initiates a JavaScript and directs the user's machine to send a call or request to a URL address, such as “http://ext.plansoft.com/jswrapper.asp?tab=0&xrot=forum” for the functions of the JavaScript. Once returned, those commands are executed resulting in the masthead 104 and the script terminates.

The following description relates to an example of implementation of the present invention.

In this example, the interface with many different 3rd parties and their web sites is simplified, and presents a method of maintaining a single location for navigation and to provide the ability for the 3rd parties to call this navigation. It is desired that the method provide an easy to use solution that allows 3rd parties to run a sites navigation from the site domain and provide a central location of maintenance for navigation source code. The method also eliminates the need for the 3rd parties to write/maintain source code relating to a particular sites navigation and Masthead.

The dynamic navigation generation in this example may be accomplished by the use of several methods within the site COM objects.

First Method: OpenAsJavaScriptOutput

Input: strLocation—a string containing a URL
Output: the resultant JavaScript code
Function: Accepts a URL as input and generates JavaScript code, which writes the results of the supplied URL to the current document.

Source Code:

```
    Public Function OpenAsJavaScriptOutput(ByVal vstrLocation As
String) As String
    Dim strJS As String
    Dim arrOut As Variant
    Dim i As Long
    Dim strErrMsg As String
    On Error GoTo ErrorHandler:
    strJS = OpenAsTextStream(vstrLocation)
    ‘split the textstream into individual lines
    arrOut = Split(strJS, vbCrLf)
    ‘now format for JavaScrip output
    strJS = “with (document) {“& vbCrLf
    For i = 0 To Ubound(arrOut)
      If TrinWS9arrOut(i)) <>“” Then
        arrOut(i) = Replace(arrOut(i), “\”, “\\”)
        arrOut(o) = Replace(arrOut(i), vbTab, “\t”)
        arrOut(i) = Replace(arrOut(i), “’”, “\””)
        arrOut(i) = Replace(arrOut(i), “””, “\”””)
        strJS = strJS & “ writeIn(“”” & arrOut(i) & “””); “ & vbCrLf
        End If
      Next
      strJS = strJS & “}” & vbCrLf
    OpenAsJavaScriptOutput = strJS
    Exit Function
  ErrorHandler:
    strErrMsg = TypeName(Me) & “.OpenAsJavaScriptOutput -
    “ & Err.Description
    Call LogEven(enError, strMsg)
    OpenAsJavaScriptOutput = “document.writein(“ ”<P>ERROR: “ &
strErrMsg & “ ””</P>); “ & vbCrLf
    End Function
```

Second Method: OpenAsTextStream
Input: strLocation—a string containing a URL
Output: the results of the HTTP request generated from the supplied URL.
Function: Accepts a URL as input. Posts an HTTP request to the supplied URL and returns the results of that request. In essence, this method acts as a mini web-browsers to “screen scrape” the HTML generated by the request.

Source Code:

```
  Public Function OpenAs TextStream(ByVal vstrLocation As String)
  As String
        Dim objHTTPReq As MSXML2.XMLHTTP
        Dim strErrMsg As String
        On Error Go To ErrorH
        Set objHTTPReq = New MSXML2.XMLHTTP
        Call objHTTPReq.open(“GET”, vstrLocation, False)
        Call objHTTPReq.send
        OpenAsTextStream = objHTTPReq.responseText
        Set objHTTPReq = Nothing
        Exit Function
        ErrorH:
        StrErrMsg = TypeName(Me) & “.OpenAsTextStream - “ &
vbCrLf & Err.Description
        Set objHTTPReq = Nothing
        Call LogEvent(enError, strErrMsg)
        OpenAsTextStream = “<P>ERROR: “& strErrMsg & “</P>”
      End Function
```

Usage Notes

The Web server then calls the OpenAsJavaScriptOutput method with the URL; as for example: http://ext.plansoft.com/header.asp. This returns the JavaScript output for the PlanSoft site navigation.

In this example, the PlanSoft site may use the Microsoft XML parser to retrieve the HTTP response from the URL. A UNIX based server will have to use a CGI script or Java Servlet to serve this purpose.

Resultant Javascript

The following is the resultant javascript:

```
    function ShowHeader( ) {
    with (document) {
    writeIn(“<html>”);
    writeIn(“<head>”);
    writeIn(“ <TITLE>PlanSoft</TITLE>”);
    writeIn(“<script
language=\”javascript\”src=\”/global/src/common.js\”></script>”);
  writeIn(“ <LINK REL=\”stylesheet\” HREF=\”/global/src/common.css\”
TYPE=\”text/css\”>”);
  writeIn(“ <LINK REL=\”stylesheet\”HREF=\”/src/site.css\”TYPE=”text/css\”>”);
  writeIn(“</head>”);
  writeIn(“<body bgcolor=\”#FFFFFF\” leftmargin=\”0\”topmargin=\”0\”
background=\”/images/topbg2.gif\”marginwidth=\”0\”marginheight=\”0\”>);
  writeIn(“<STYLE>”);
  writeIn(“ \tBODY { background-repeat : repeat-x; }”);
  writeIn<divclass=\”masthead\”>”;
  writeIn(“ </STYLE> “);
  writeIn(“<table cellspacing=\”0\” cellpadding=\”0\” BORDER=\”0\”
bordercolor=\”yellow\”width\”1--%\”>”);
  writeIn(“<tr>”);
  writeIn(“\t<td width=\”232\”><img src=\””/images/shim.gif\” width=\”183\”height=\”1\”
alt=\”\”border=\”0\”></td>”);
  writeIn(“\t<td width=\”77\”><img src=\”/images/shim.gif\” width=\”77\”height=\”1\”
alt=\”\”border=\”0\”></td>”);
  writeIn(“ <td width 100%></td>”);
  writeIn(“</tr>”);
  writeIn(“<tr>”);
  writeIn(“  <td width=\”232\”>”);
  writeIn(“t<table border=0 cellpadding=0 cellspacing=0>”);
  writeIn(“\t <tr>”);
  writeIn(“\t <td><a href=\”http://www.mpoint.com/index.asp\”><img alt=\”mpoint\”
src=\”/images/logo.gif\” width=\”155\” height=\”80\”border=\”0\”></td>”);
  writeIn(“\t <td rowspan=\”2\”><img alt=\”mpoint\” src=\”/images/logo.right.gif\”
width=\”77\” height=\”84\”border=\”0\”></a></td>”);
  writeIn(“  </tr>);
  writeIn(“\t <tr>”);
  writeIn(“\t  <td><img alt=\”mpoint\” src=\”/images/logo.bot.gif\” width=\”155\”
height=\”4\”border=\”0\”></td>”);
  writeIn(“  </tr>”);
  writeIn(“\t</table></td>”);
  writeIn(“\t<td width=\”77\” valign=\”bottom\”>”);
  writeIn(“\t<tableborder=\”0\”cellpadding=\”0\” celspacing=\”0\”>”);
  writeIn(“\t <tr>”);
  writeIn(“\t<td><img alt=\”newnew2_03\”src=\”/images/newnew2_03.gif\”width=\”77\”
height=\”16\”border=\”0\”></td”);
  writeIn(“\t </tr>”);
  writeIn(“\t </tr>”);
  writeIn(“\t <td><a href=\”http://bbs.mpoint.plan-soft.com/forums.cfm\”><img
alt=\”forum\”
src=\”/images/newnew2_05.gif\”width=\”77\”height=\”13\”border=\”0\”></a></td>”);
  writeIn(“\t </tr>”);
  writeIn(“\t <tr>”);
  writeIn(“\t <td><a
href=\”javascript:EmailPopup(\’http://www.mpoint.com/global/community/login.asp?PAGEACTION=
login\’);\”><img
alt=\”email\”scr=\”/images/newnew2_06.gif\”width=\”77\”height=\”12\”border=\”0\”></a></td>”);
  writeIn(“\t </tr>”);
  writeIn(“\t <tr>”);
  writeIn(“\t<td><a href=\”http://jobs.mpoint.com/\”><img
alt=\”career\”src=\”/images/newnew2_07.gif\”width=\”77\”height=\”12\”border=\”0\”></a></td>”);
  writeIn(“\t </tr>”);
  writeIn(“\t <tr>”);
  writeIn(“\t <td><a href=\”http://news.mpoint.plan-soft.com/listpr.cfm\”><img
alt =\”news\”src=\”/images/newnew2 -
08.gif\”width=\”77\”height=\”11\”border=\”0\”></a></td>”);
  writeIn(“\t </tr>”);
  writeIn(“\t <tr>”);
  writeIN(“\t <td><img
alt=\”my\”\src=\”/images/newnew2_09.gif\”width=\”77\”height=\”20\”border=\”0\”></td>”);
  writeIn(“\t </tr>”);
  writeIn(“  </table>”);
  writeIn(“ </td>”);
  writeIn(“ <td valign=\“bottom\” align=\“center”>”);
  writeIn(“<a name=\“AdRot\”
href=\“http://www.mpoint.com/global/includes/banner_ClickLog.asp?URL=http://www.mpoint.
com/misc/promostart.asp&bannerid=141&bannerowner=sweepstakes&exclusiveid=0&rotation
id=297&facid=0&bannertype=All&location=header&path_info=/header.asp\”
target=\“_blank\”><IMG SRC=\“/global/banners/ad-mpnt-010112b.gif\” ALT=“Plan a great
meeting and WIN a $1000 shopping spree\” border=\“0\” WIDTH=\“468\”
HEIGHT=\“60\”></a>”);
  writeIn(“ </td>”);
  writeIn(“</tr>”);
  writeIn(“ <tr bgcolor=\“#ffffcc\” valign=bottom>”);
  writeIn(“ <td valign=\“middle\” align=“left\”>”);
  writeIn(“ <form method=\“post\” action=\“http://search.mpoint.plan-soft.com/htdig/cgi-
bin/htsearch.cgi\”>”);
  writeIn(“  <input type=\“hidden\” name=\“method\” value=\“or\”>”);
  writeIn(“  <input type=\“hidden\” name=\“format\” value=\“builtin-long\”>”);
  writeIn(“  <input type=\“hidden\” name=\“sort\” value=\“score\”>”);
  writeIn(“  <input type=\“hidden\” name=\“restrict\” value=\“\”>”);
  writeIn(“  <input type=\“hidden\” name=\“exclude\” value=\“\”>”);
  writeIn(“  <input type=\“hidden\” name=\“config\” value=\“plansoft\”>”);
  writeIn(“  <table border=0 cellpadding=0 cellspacing=0 class=\“search\”>”);
  writeIn(“  <tr>”);
  writeIn(“/t  <td><img src=\“/images/shim.gif\” width=10 height=10 alt=\“\”
border=\“0\”></td>”);
  writeIn(“\t  <td><span class=\“caption\”>search&nbsp;</span></td>”);
  writeIn(“\t  <td><input type=\“text\” size=\“10\” name=\“words\”></td>”);
  writeIn(“\t  <td>&nbsp;</td>”);
  writeIn(“\t  <td><input type=\“image\” scr\“/images/go.gif\” width=\“20\” height=\“20\”
alt=\“go\” border=\“0\”></td>”);
  writein(“\t </tr>”);
  writein(“  </table>”);
  writein(“ </td>”);
  writein(“ <td align=\“right\” valign=\“bottom\” colspan=\“3\>”);
  writein(“ <table cellpadding=\“0\” cellspacing=\“0\” border=\“0\”>”);
  writein(“ <tr valign=\“bottom\”>”);
  writein(“t\t <td valign=\“bottom\”><a href=\“/search_section/search_intro.asp\”><IMG
alt\“\” border=0 scr=\“/images/0off.gif\” width=\“179\” height=\“17\”></a></td>”);
  writein(“\t\t <tdvalign=\“bottom\”><a href=\“/rfp_section/rfp_neg_intro.asp\”><IMG alt=\“\”
border=0 src=\“/images/1off.gif\” width=\“151\” height=\“17\”></a></td>”);
  writein(“t\t <td valign=\“bottom\”><a
href=\“/mtgmgmt_section/meeting_mgmt_intro.asp\”><IMG alt=\“\” border=0
src=\“/images/2off.gif\” width=\“178\” height=\“17\”></a></td>”);
  writein(“\t</tr>”);
  writein(“  </table></td>”);
  writein(“ </tr>”);
  writein(“ <tr valign=\“middle\”>”);
  writein(“  <td colspan=\“3\” bgcolor=\“#336699\” height=\“20\”>”);
  writein(“  <div class=\“nav\”>”);
  writein(“  <table width=\“100%\” cellspacing=\“0\” cellpadding=\“0\” border=\“0\”>”);
  writein(“  <tr valign=\“middle\”>”);
  writein(“ \t <td align=\“left\”>”);
  writein(“  <table cellspacing=\“0\” cellpadding=\“0\” border=\“0\” height=\“20\”>”);
  writein(“  <tr>”);
  writein(“ \t  <td valign=\“middle\” width=\“10\”><img src=\“/images/shim.gif\” width=10
height=1 alt=\“\” border=\“0\”></td”);
  writeIn(“ \t <td
valign=\”middle\”width=\”50\”><ahref=\”http://www.mpoint.com/index.asp\”>home</a></td>”);
  writeIn(“  <td valign+\”middle\”width=\”8\”>&nbsp;</td>”);
  writeIn(“\t  <td valign=\”middle\”width=\”50\”><a
href=\”javascript:popup(\’http://www.mpoint.com/global/misc/800help.asp?\’);\”>help?</a></td>”);
  writeIn(“\t\t  <td valign=\”middle\”width=\”8\”>&nbsp;</td>”);
  writeIn(“\t <td valign=\”middle\”width=\”50\”><a
href=\”http://www.mpoint.com/misc/welcome.asp\”>about</a></td>”);
  writeIn(“  </tr>”);
  writeIn(“  </table></td>”);
  writeIn(“\t <td align=\”right\”valign=\”middle\”><table border=0
cellpadding=0cellspacing=0></table></td>”);
  writeIn(“\t </tr>”);
  writeIn(“  </table>”);
  writeIn(“ </td>”)’
  writeIn(“ </div>”);
  writeIn(“ </tr>);
  writeIn(“</form>”);
  writeIn(“</table>);
  writeIn(“</div>\t”);
  writeIn(“<center>”);
  writeIn(“<TABLEBORDER=\0\”bordercolor=\”lime\”CELLPADDING=\”0\”
CELLSPACING=\”0\”WIDTH=\”780\”>”);
  writeIn(“\t<TR VALIGN=\”top\”>”);
  writeIn(“\t\t<TD VALIGN=\”TOP\” class=\”content\” ALIGN=\”middle\”>”);
  }
  }
```

This can also be referenced directly from a site, such as via the PlanSoft site URL http://ext.plansoft.com/jswrapper.asp. View Source in your browser to see the JavaScript functions.
Requirements of the 3rd Party

3rd Parties are required to put the following items within tehir source code.

<html>
<head>
<script language=”javascrip”
src=”http://ext.plansoft.com/jswrapper.asp?tab=0&linkref=
page1.html|Page+1|page2.html|Page+
2|page3.html|Page+3|page4.html|this+is+the+last+page”></script>
<script language=”javascript”<ShowHeader( );</script>
</head>
<body>
<base href=”http://www.your_site_name_here.com/”>
<p>Here's where the client content would go...</p>
<script language=”javascript”>ShowFooter( );</script>
</body>
</html>

While the present invention has been described with reference to a dynamic navigation embodiment, the same methods could be applied to other web content. It should be appreciated that such alternative applications fall within the scope of the preferred invention.

1. A system for providing a dynamically updated navigation portion of a web page comprising:
a computing device;
a web page displayed on said computing device;
a conversion utility accessible via a global information system; and
a file having navigation source code, wherein when the web page is loaded by the computing device, the web page sends a request for resultant code to the conversion utility and wherein the conversion utility upon receiving the request retrieves the file having navigation source code and converts the navigation source code into a file having resultant code, and wherein the file having resultant code is transmitted to the computing device and loaded in conjunction with the web page so as to automatically update the navigation portion of the web page.

2. A method for loading a web page with a dynamically updated navigational masthead comprising the steps of:
a) initiating page load of a web page displayed on a computing device;
b) initiating load of a navigation masthead within the web page displayed on the computing device;
c) sending from the computing device a request for resultant code to a conversion utility;
d) receiving from the conversion utility the resultant code; and
e) executing the resultant code, wherein the step of executing the resultant code completes the load of the navigation masthead of the web page.

3. A method for providing a dynamically updated navigational masthead comprising the following steps:
a) embedding source code on a web page capable of sending a request for resultant code, wherein the web page loads on a user's computing device;
b) receiving from the user's computing device a request for resultant code, wherein the receipt occurs electronically;
c) retrieving a file having navigation source code;
d) converting the navigation source code into resultant code; and
e) sending the resultant code to said user's computing device.
